(19) United States
(12) Patent Application Publication
(10) Pub. No.: US 2023/0083943 A1
(43) Pub. Date: Mar. 16, 2023

(54) MEDICAL SWAB STORAGE METHOD AND MEDICAL SWAB STORAGE DEVICE

(71) Applicant: PIPESH NANO SECONDS INC., Tokyo (JP)

(72) Inventors: Masaaki YAMADA, Tokyo (JP); Yoshitaka HIGASHIDA, Tokyo (JP)

(73) Assignee: PIPESH NANO SECONDS INC., Tokyo (JP)

(21) Appl. No.: 17/801,419

(22) PCT Filed: Mar. 19, 2021
(86) PCT No.: PCT/JP2021/011359

§ 371 Date: Aug. 22, 2022

(30) Foreign Application Priority Data
Mar. 23, 2020 (JP) 2020-051835

(51) Int. Cl. B25J 9/16; B65B 69/00; B25J 13/08; G06T 7/50

(52) U.S. Cl. CPC B25J 9/1687; B65B 69/00; B25J 9/1697; B25J 13/08; G06T 7/50

(57) ABSTRACT

An operation of storing a medical swab in a storing portion of a medical plate can be performed automatically. A medical swab storing method includes: grasping a medical swab having collected a specimen, by using a grasping portion provided in a robot arm; moving grasped medical swab to a position above a predetermined storing portion of a predetermined plate; and storing medical swab in the predetermined storing portion of the predetermined plate. A medical swab storing apparatus includes: a robot arm including a grasping portion; and control means configured to control the robot arm. The robot arm operates so as to move the grasped medical swab to a position above a predetermined storing portion of a predetermined plate and release grasp by the grasping portion above the predetermined storing portion so that the medical swab is stored in the predetermined storing portion, under control of the control means.

### TECHNICAL FIELD

The present invention relates to a medical swab storing method and a medical swab storing apparatus for storing a medical swab (hereinafter simply referred to as “swab”) in a storing portion of a medical plate (hereinafter simply referred to as “plate”).

### BACKGROUND ART

In collecting a specimen, a cotton swab called a swab is used (for example, Patent Literature 1). A swab illustrated in FIG. 13(a) to FIG. 13(c) as an example is a member including a collecting portion X7 at one end of a shaft portion X6, and a cap X5 is mounted at another end of the shaft portion X6. The swab is stored and preserved in a storing tube X2 having a bottomed-cylinder shape. When the swab is stored in the storing tube X2, an opening of the storing tube X2 is closed by the cap X5 mounted to the swab.

The swab that has collected a specimen is taken out from the storing tube X2 and is stored in an individual storing portion of a plate including a plurality of storing portions, on a one-by-one basis. In this operation, it is required to exercise utmost caution to avoid problems such as mix-up of specimens, errors in records on storing of specimens, and contamination (mixture).

Conventionally, the above-mentioned operation has been performed manually by a researcher. However, there is a limitation to a human concentration span, and a risk of mis-operation is increased with passage of time. Further, a situation in which a person having expertise is required to take time to do simple work is undesirable in terms of research and development. For this reason, there is a demand for proposal for means capable of automating the above-mentioned operation.

However, a swab is liable to vibrate and is often curved after collecting a specimen, and hence it is not easy to automatically store the swab in a storing portion having so small an insertion port as approximately 8 mm×8 mm. Thus, in reality, there has been no proposal for an apparatus capable of automating the above-mentioned operation.

### CITATION LIST

### Patent Literature

[PTL 1] JP 2007-523663 A

### SUMMARY

### Technical Problem

The present invention has been made under the circumstances described above, and its object to achieve is to provide a medical swab storing method and a medical swab storing apparatus that can automatically perform an operation of storing a swab in a storing portion of a plate.

### Solution to Problem

[Medical Swab Storing Method]

A medical swab storing method according to the present invention is a method of storing a swab in a storing portion of a plate, including: grasping the swab having collected a specimen, by using a grasping portion provided in a robot arm; moving the grasped swab to a position above a predetermined storing portion of a predetermined plate; and storing the swab in the predetermined storing portion of the predetermined plate. In this case, the swab may be stored in the predetermined storing portion after being stopped for a predetermined period of time.

In the medical swab storing method, a cap of the swab may be removed before the swab is moved to the position above the predetermined storing portion of the predetermined plate.

The medical swab storing method may further include: photographing the swab grasped by the grasping portion, by using photographing means; specifying a shape of the swab from a photographed image obtained by the photographing; and determining whether the specified shape complies with a standard set in advance. A position of the medical swab can be corrected when the specified shape does not comply with the standard. The position of the medical swab can be corrected, for example, by moving the robot arm in an X-axis direction and/or a Y-axis direction on an imaginary plane parallel to an upper surface of the plate.

The medical swab storing method may further include: reading an identification code indicated on a storing tube in which the swab is stored, by using reading means; and storing the swab in a storing portion of a plate designated by the identification code.

In the medical swab storing method, before the swab is stored in the storing portion of the plate designated by the identification code, determination may be made on whether the plate includes a vacant storing portion capable of receiving the swab.

The medical swab storing method may further include: putting the swab grasped by the robot arm into uncapping means; fixing a storing tube of the swab by using fixing means of the uncapping means; and taking off the cap by causing a pulling-up unit in contact with a cap of the medical swab to operate.

[Medical Swab Storing Apparatus]

A medical swab storing apparatus according to the present invention is an apparatus that stores a swab in a storing portion of a plate, and includes: a robot arm including a grasping portion; and control means configured to control the robot arm. The robot arm operates so as to move a grasped swab to a position above a predetermined storing portion of a predetermined plate and release grasp by the grasping portion above the predetermined storing portion so that the swab is stored in the predetermined storing portion, under control of the control means. The robot arm may stop for a predetermined period of time above the predetermined storing portion under control of the control means.

The medical swab storing apparatus can further include removing means configured to remove a cap of the swab. In this case, the robot arm can operate so as to move the grasped swab to a removal position of the removing means under control of the control means, and the cap of the swab moved to the removal position can be removed by the removing means.

The medical swab storing apparatus can further include photographing means configured to photograph the swab grasped by the grasping portion. In this case, a shape of the swab is specified from a photographed image obtained by the photographing, and determination can be made on whether the specified shape complies with a standard set in advance. The medical swab can be corrected when the specified shape does not comply with the standard set in advance. The medical swab can be corrected by moving the robot arm in an X-axis direction and/or a Y-axis direction on an imaginary plane parallel to an upper surface of the plate.

The medical swab storing apparatus can further include reading means configured to read an identification code indicated on a storing tube in which the swab is stored. In this case, the robot arm can operate so as to store the swab in a storing portion of a plate designated by the identification code under control of the control means.

In the medical swab storing apparatus, determination can be made on whether the plate designated by the identification code includes a vacant storing portion capable of receiving the medical swab.

The medical swab storing apparatus can further include uncapping means configured to take off a cap of the swab from a storing tube. The uncapping means can include fixing means configured to fix the storing tube, and a pulling-up unit configured to come into contact with the cap and pull up the cap.

### Advantageous Effects of Invention

With the medical swab storing method and the medical swab storing apparatus according to the present invention, it is possible to automate an operation of storing a swab in the storing portion of the plate, which can encourage reduction of a contamination risk and reduction of a period of time that a researcher having expertise is required to take to do simple work.

### BRIEF DESCRIPTION OF DRAWINGS

FIG. 1 is a flowchart for illustrating an example of a medical swab storing method according to the present invention.

FIG. 2 is a perspective view for illustrating an example of a medical swab storing apparatus according to the present invention.

FIG. 3 (a) is an explanatory view for illustrating an example of a method of specifying an outline shape and a central point, and FIG. 3(b) is an explanatory view for illustrating an example of a reference frame and an insertion port.

FIG. 4 is a block diagram for illustrating an example of a control device.

FIG. 5 is a perspective view for illustrating an example of a plate seat and a plate.

FIG. 6(a) is a perspective view for illustrating an example of a stocker, and FIG. 6(b) is an explanatory sectional view of the stocker.

FIG. 7 is a perspective view for illustrating an example of photographing means.

FIG. 8 is a perspective view for illustrating an example of uncapping means.

FIG. 9(a) to FIG. 9(e) are explanatory views for illustrating an operation of the uncapping means illustrated in FIG. 8.

FIG. 10 is a flowchart for illustrating an example of operations of the medical swab storing apparatus.

FIG. 11 is a flowchart for illustrating an example of operations of the medical swab storing apparatus.

FIG. 12 is a flowchart for illustrating an example of operations of the medical swab storing apparatus.

FIG. 13(a) to FIG. 13(c) are explanatory views for illustrating an example of a swab that is an object to be processed in the present invention.

### DESCRIPTION OF EMBODIMENTS

(Embodiment of Medical Swab Storing Method)

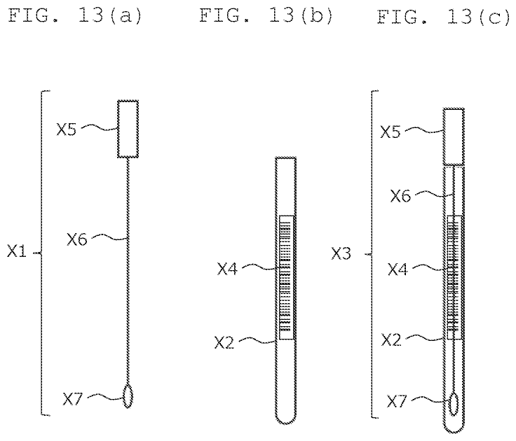

An example of an embodiment of a medical swab storing method (hereinafter referred to as “storing method”) according to the present invention is described with reference to the drawings. The storing method according to the present invention is a method of taking out a swab stored in a storing tube X2 as illustrated in FIG. 13 from the storing tube X2 and storing the swab in a predetermined storing portion (hereinafter referred to as “predetermined storing portion”) 14a of a predetermined plate (hereinafter referred to as “predetermined plate”) 14. Note that, for convenience of description, in the following, a cotton swab used for collecting a specimen may be referred to as a swab, a swab provided with a cap at an upper end thereof may be referred to as a capped swab X1, and the capped swab X1 stored in the storing tube X2 may be referred to as a packed swab X3.

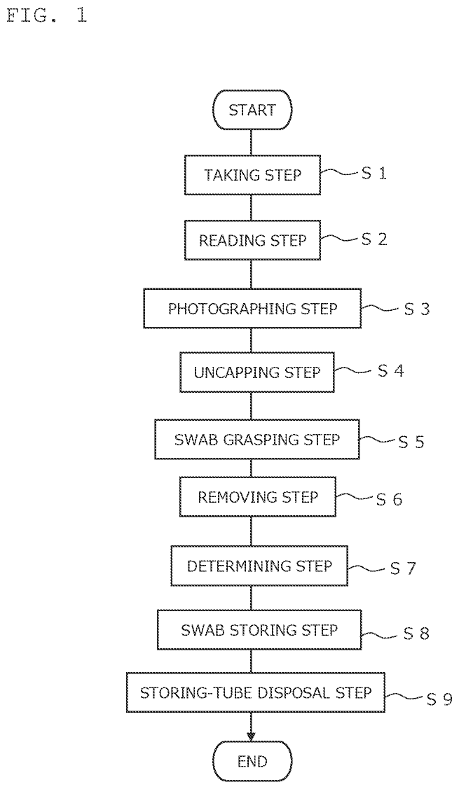

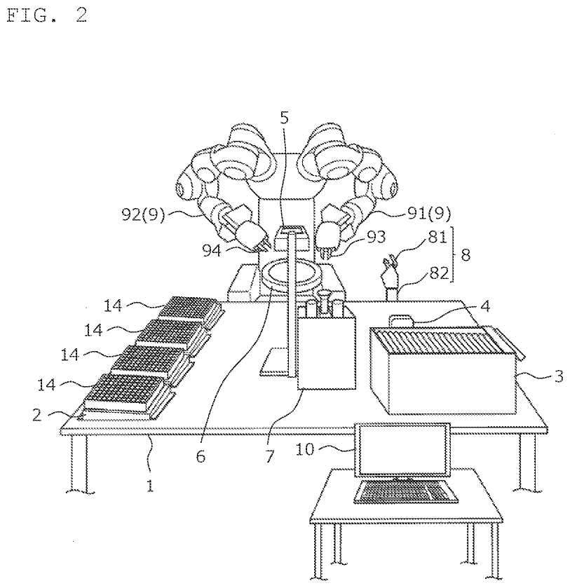

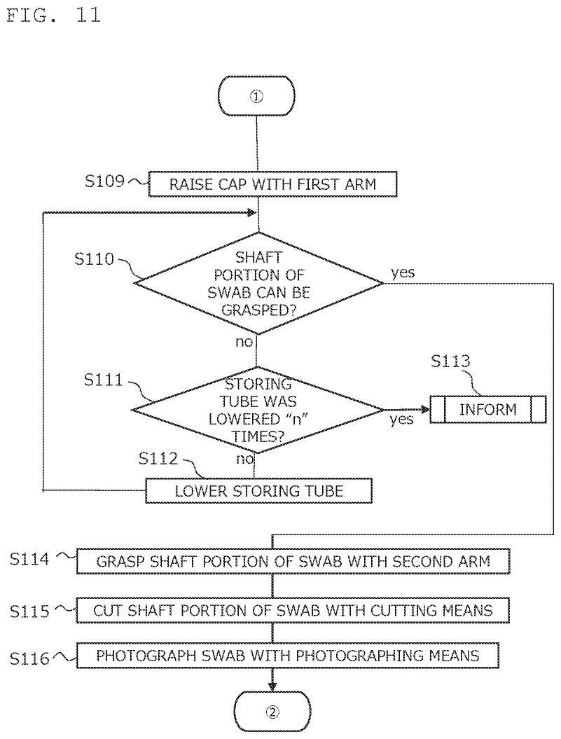

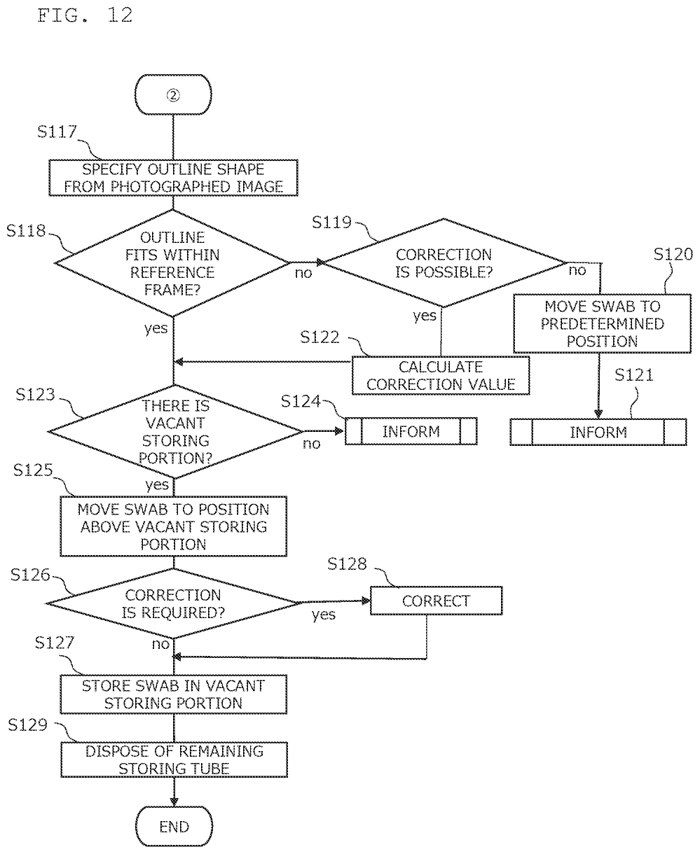

The storing method illustrated in FIG. 1 as an example includes a taking step S1, a reading step S2, a photographing step S3, an uncapping step S4, a swab grasping step S5, a removing step S6, a determining step S7, a swab storing step S8, and a storing-tube disposal step S9. The method can be performed, for example, by using an apparatus as illustrated in FIG. 2. Reference symbols in this embodiment correspond to those in FIG. 2 to FIG. 13.

The taking step S1 is a step of taking out the packed swab X3 having collected a specimen by using a first robot arm (hereinafter referred to as “first arm”) 91 including a grasping portion 93. In this step, the grasping portion (hereinafter referred to as “first grasping portion”) 93 of the first arm 91 grasps one packed swab X3 discharged to a receiving portion 34 of a stocker 3. In this embodiment, a cap X5 of the packed swab X3 is grasped.

The reading step S2 is a step of reading an identification code X4 indicated on the packed swab X3 by using reading means 4. The indication referred to here includes indication by affixation of a seal having the identification code X4 printed thereon and further includes indication by printing of the identification code X4 directly on the storing tube X2.

In this step, the first arm 91 moves the packed swab X3 to a reading position of the reading means 4, and the reading means 4 reads the identification code X4 indicated on the packed swab X3.

The identification code X4 can be read under a state in which the packed swab X3 is stopped and under a state in which the packed swab X3 is rotated in a forward direction or a backward direction. The reading performed under the state in which the packed swab X3 is rotated in the forward direction or the backward direction enables correct and reliable reading also in a case in which the identification code X4 is indicated obliquely with respect to a longitudinal axis of the storing tube X2.

The photographing step S3 is a step of photographing the packed swab X3 by using photographing means 5. In this step, the first arm 91 moves the packed swab X3 to a photographing position of the photographing means 5, and the photographing means 5 photographs the packed swab X3.

The identification code X4 indicated on the packed swab X3 is indicated obliquely with respect to the longitudinal axis of the storing tube X2 in some cases, and hence, it is preferred to photograph the packed swab X3 a plurality of times while rotating the packed swab X3 in the forward direction and the backward direction. A photographed image ensures traceability (capability to trace). Further, a photographed image can be used for checking the identification code X4 read by the reading means 4.

The uncapping step S4 is a step of taking off the cap X5 of the packed swab X3 from the storing tube X2. In this step, the first arm 91 puts the packed swab X3 into uncapping means 7, and the uncapping means 7 takes off the cap X5 from the storing tube X2.

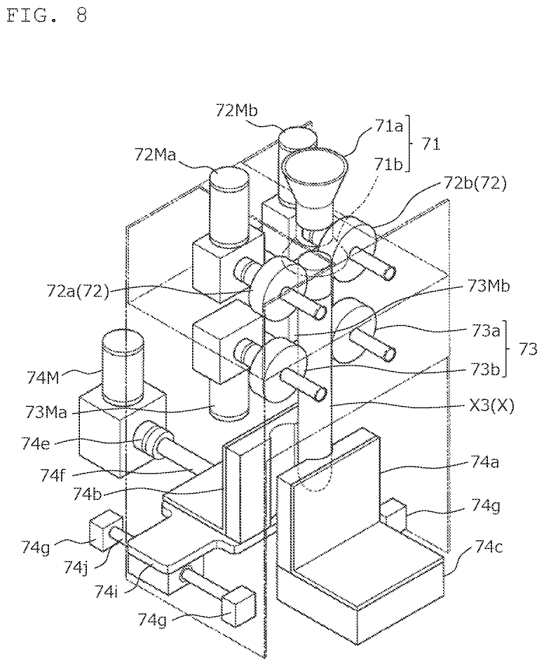

In this embodiment, the storing tube X2 of the packed swab X3 put into the uncapping means 7 is fixed by using a fixing vise 74, and the cap X5 of the packed swab X3 is clamped by a pulling-up unit 72 (in this embodiment, upper rollers 72a and 72b illustrated in FIG. 8). The cap X5 is taken off by a force applied due to the operation of the pulling-up unit 72 (in this embodiment, a rotational force of the upper rollers 72a and 72b). The packed swab X3 from which the cap X5 has been taken off is fed upward by a force applied due to the operation of the pulling-up unit 72.

The swab grasping step S5 is a step of grasping the capped swab X1 of the packed swab X3. In this step, the first arm 91 raises the capped swab X1, and a grasping portion (hereinafter referred to as “second grasping portion”) 94 of a second robot arm (hereinafter referred to as “second arm”) 92 grasps a shaft portion X6 of the capped swab X1. The grasping position is preferably closer to the collecting portion X7 than the center of the shaft portion X6.

In a case in which the cap X5 is not taken off from the storing tube X2 and the storing tube X2 is raised together with the capped swab X1 when the first arm 91 raises the capped swab X1, the second arm 92 grasps the storing tube X2 and lowers the storing tube X2. Then, while the cap X5 is separated away from the storing tube X2, the second arm 92 grasps the shaft portion X6 again. The second arm 92 may lower the storing tube X2 a plurality of times.

The removing step S6 is a step of removing the cap X5 of the capped swab X1. This embodiment exemplifies a case in which cutting means (removing means) 8 cuts the shaft portion X6 of the capped swab X1 to remove the cap X5. In this step (cutting step), the second arm 92 moves the capped swab X1 to a cutting position of the cutting means 8, and the cutting means 8 cuts the shaft portion X6 of the capped swab X1. The cutting of the cutting means 8 is performed based on a signal from a robot arm 9. The cutting position of the cutting means 8 is preferably above (closer to the cap X5 than) the grasping position of the second grasping portion 94 of the second arm 92. In the following, a case in which the cap X5 is removed by cutting is described as an example, but the cap X5 can be removed also by methods other than cutting.

The determining step S7 is a step of determining whether a shape of a swab complies with a standard set in advance. In this step, the second arm 92 moves a swab X to the photographing position of the photographing means 5, and the photographing means 5 photographs the swab X. The swab is placed such that a tip end thereof (the collecting portion X7) faces the front of the photographing means 5, and is photographed from the tip end thereof. In this step, whether the shape of the swab complies with the standard set in advance is determined from an image obtained by the photographing.

In this embodiment, determination is made on whether the shape (a shape of a contour or shapes of a contour and a shaft portion, hereinafter collectively referred to as “outline shape”) 16 of the swab specified from a photographed image 15 fits within a reference frame 18 set in advance, to thereby determine whether the outline shape 16 complies with the standard. The determination is made by a computer (hereinafter referred to as “PC”) 12, and the outline shape 16, the reference frame 18, a result of determination, and the like are displayed on a monitor 10.

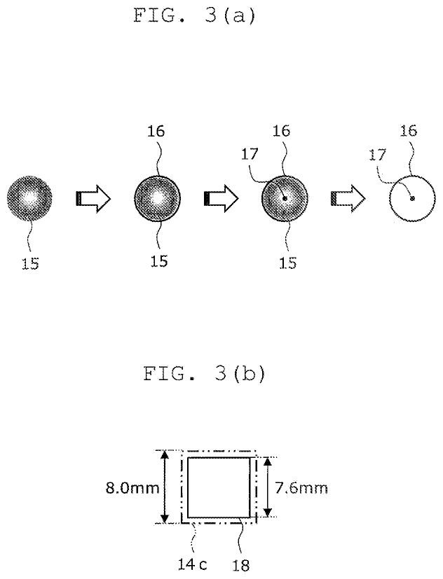

In this embodiment, as illustrated in FIG. 3(a), the outline shape 16 is specified from the photographed image 15. At that time, a central point 17 can be calculated from the specified outline shape 16. A correction value described later can be calculated based on the central point 17.

As the reference frame 18, a square frame as illustrated in FIG. 3(b) can be used, for example. The square frame of this embodiment is set to have a size of 7.6 mm×7.6 mm, smaller than the actual size (8 mm×8 mm) of an insertion port 14c of the plate 14. Use of a frame smaller than the actual insertion port 14c improves storing accuracy, and hence the problem of contamination is less liable to occur.

When the outline shape 16 fits within the reference frame 18, it is determined that the outline shape 16 complies with the standard, and the process proceeds to the swab storing step S8. Meanwhile, when the outline shape 16 does not fit within the reference frame 18, it is determined that the outline shape 16 does not comply with the standard, and determination is made on whether correction is possible. When it is determined that correction is possible, a correction value thereof is calculated in the PC 12, and correction is performed in accordance with the correction value immediately before the swab is stored in the storing portion 14a.

The swab storing step S8 is a step of storing the swab X having been cut in the predetermined storing portion 14a of the predetermined plate 14. In this step, the second arm 92 moves the swab X having been cut to a position above the predetermined plate 14. Then, in a case in which the plate 14 includes a storing portion that is vacant (hereinafter referred to as “vacant storing portion”) 14a, the swab X having been cut is stored in the vacant storing portion 14a.

The storing-tube disposal step S9 is a step of taking out the storing tube X2 remaining in the uncapping means 7 and disposing of the storing tube X2 in a disposal box (not shown). In this step, the first arm 91 takes out the storing tube X2 remaining in the uncapping means 7, moves the storing tube X2 to a position above the disposal box, and disposes of the storing tube X2 in the disposal box. This step is performed after storing of the swab in the predetermined storing portion 14a is completed.

This embodiment has exemplified a case in which the steps from the taking step S1 to the storing-tube disposal step S9 are performed in a series of steps, but each of the above-mentioned steps or each group including some of the steps can also be performed individually. Further, all of the above-mentioned steps are not essential steps, and a step which is not required can be omitted as appropriate. For example, the photographing step S3 can be omitted when recording is not required. The removing step S6 can be omitted when the storing portion 14a can receive a capped swab as it is.

(Embodiment of Medical Swab Storing Apparatus)

Next, an example of an embodiment of a medical swab storing apparatus (hereinafter referred to as “storing apparatus”) according to the present invention is described with reference to the drawings. The storing apparatus according to the present invention is an apparatus that takes out the capped swab X1 as illustrated in FIG. 13 from the storing tube X2 and stores the capped swab X1 in the predetermined storing portion 14a of the predetermined plate 14.

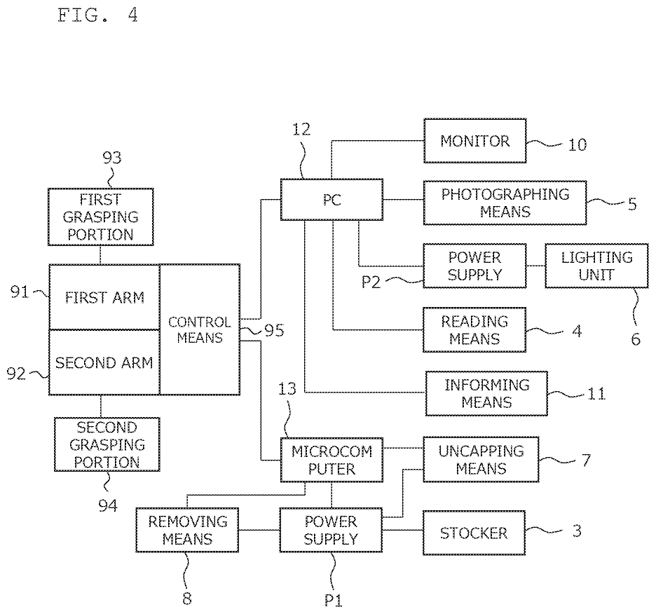

The storing apparatus illustrated in FIG. 2 and FIG. 4 as an example includes a setting stand 1, a plate seat 2, the stocker 3, the reading means 4, the photographing means 5, a lighting unit 6, the uncapping means 7, the removing means 8, the robot arm 9, the monitor 10, informing means 11, the PC 12, and a microcomputer 13.

The setting stand 1 is a stand on which various devices such as the plate seat 2, the stocker 3, the reading means 4, the photographing means 5, the uncapping means 7, and the removing means 8 are set. As the setting stand 1, a stainless-steel stand or the like can be used. In the example illustrated in FIG. 2, the robot arm 9 and the monitor 10 are set on stands different from the setting stand 1, but the robot arm 9 and the monitor 10 can be set on the setting stand 1.

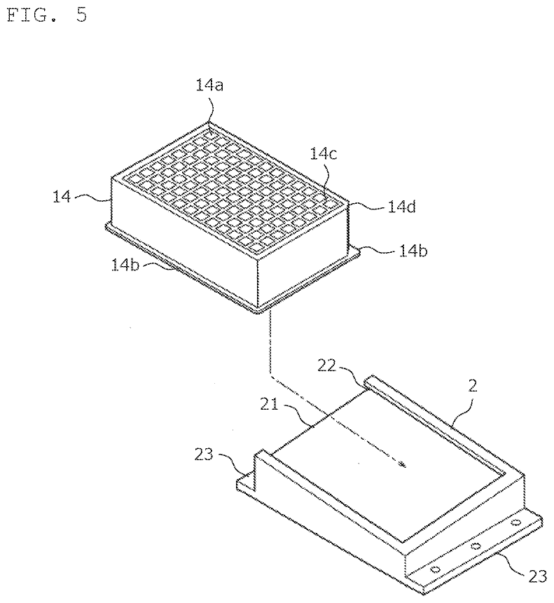

The plate seat 2 is a base member onto which the plate 14 is mounted and fixed. The plate seat 2 illustrated in FIG. 5 as an example has a rectangular shape in plan view, and a mounting surface 21 thereof is formed so as to be an inclined surface that is inclined downward toward one corner. As a result of forming the mounting surface 21 of the plate seat 2 so as to be an inclined surface, the swabs X stored in the storing portions 14a are arranged while being accumulated in the inclination direction, which produces advantages of making it difficult for the swabs to interfere with each other.

The mounting surface 21 of the plate seat 2 is provided with a fitting groove 22, and it is possible to fix the plate 14 onto the plate seat 2 only by fitting a fitting portion 14b of the plate 14 into the fitting groove 22. A flange 23 is provided in the plate seat 2 so as to protrude, and the flange 23 can be fixed to the setting stand 1 by a fastener such as a screw.

The plate 14 is a receiving container for storing the swab X. The plate 14 illustrated in FIG. 5 as an example includes the bottomed storing portions 14a each having the insertion port 14c in an upper portion thereof. The storing portions 14a are provided in 8 columns×12 rows, that is, 96 storing portions 14a are provided. The columns are marked with column numbers A to H, and the rows are marked with row numbers 1 to 12. The insertion port 14c of the storing portion 14a of this embodiment is standardized at 8 mm×8 mm. In this embodiment, the insertion port 14c having a shape of a quadrangle is described as an example, but a plate including the insertion port 14c having a circular shape can be used as the plate 14. Note that, a notched surface 14d is provided in a longitudinal side of the plate 14 so that the plate 14 can be fitted in the plate seat 2 only in one direction.

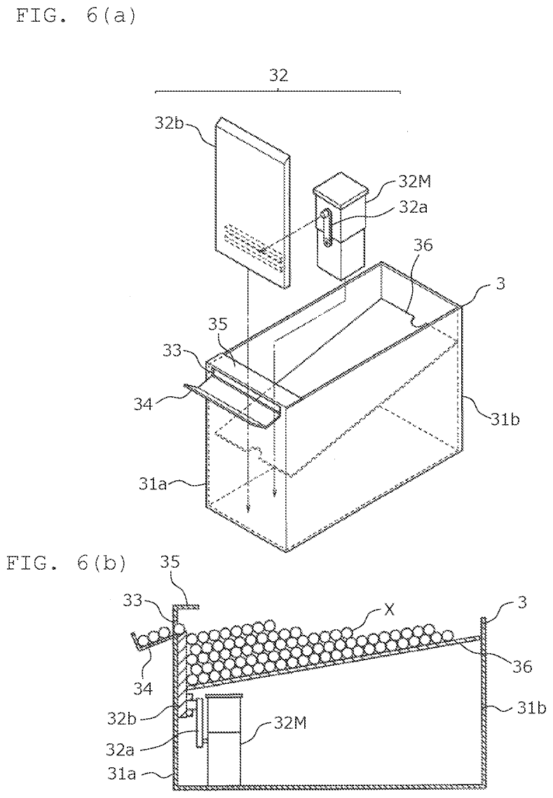

The stocker 3 is a device that stores therein the packed swab X3 having collected a specimen and feeds (discharges) the stored packed swab X3 to a position where the swab X is to be taken out. The stocker 3 illustrated in FIG. 6 as an example includes a main-body case 31 and a discharge mechanism 32 that discharges the packed swab X3 in the main-body case 31 to an outside of the main-body case 31. The main-body case 31 of this embodiment is a box having a shape of a rectangular parallelepiped that is open upward, and a discharge port 33 having a such a shape enables discharging of the packed swab X3 is provided at a portion of a board member (hereinafter referred to as “front board”) 31a forming the main-body case 31.

The receiving portion 34 that receives the discharged packed swab X3 is provided outside of the discharge port 33. The receiving portion 34 of this embodiment is a member that includes a receiving surface having a size that allows three packed swabs X3 to be placed thereon side by side. In this embodiment, a spill stopper 35 is provided in an upper surface of the main-body case 31 on a side closer to the discharge port 33 in order to prevent the packed swab X3 from being discharged from an upper-surface opening of the main-body case 31. The spill stopper 35 may be provided as required, and can be omitted when it is not required.

An intermediate board 36 on which the packed swab X3 can be placed is detachably provided in the main-body case 31. The intermediate board 36 is supported by a supporting portion (not shown) that is provided so as to protrude from an inner wall of the main-body case 31. The intermediate board 36 is provided so as to be inclined such that a side closer to the front board 31a where the discharge port 33 of the main-body case 31 is provided is lower and a side closer to a surface (back board 31b) opposite to the front board 31a is higher. A space wide enough to hold an ascending/descending unit 32b described later is secured between the intermediate board 36 and the front board 31a.

The discharge mechanism 32 that discharges the packed swab X3 to the outside of the main-body case 31 is provided below the intermediate board 36 of the main-body case 31. The discharge mechanism 32 of this embodiment includes a motor 32M (geared motor), a link member 32a coupled to an output shaft of the motor 32M, and the ascending/descending unit 32b that is moved upward and downward by the link member 32a. The ascending/descending unit 32b is positioned between the intermediate board 36 and the front board 31a.

The link member 32a is a member for transmitting a rotational force of the motor 32M to the ascending/descending unit 32b to move the ascending/descending unit 32b upward and downward. The link member 32a of this embodiment is an elongated flat-board member, and has one end coupled to the output shaft of the motor 32M. A surface of the link member 32a on another end side, that is, on a side closer to the ascending/descending unit 32b, is provided with an engagement protrusion.

The ascending/descending unit 32b is a member for feeding the packed swab X3 to the discharge port 33. The ascending/descending unit 32b of this embodiment is a flat-board member having a shape of a quadrangle. Two bars are provided at an interval in a surface on a side closer to the link member 32a, and a fitting groove is formed between the bars. In this embodiment, the upper surface of the ascending/descending unit 32b is inclined downward toward the discharge port 33. With such an inclined upper surface, the packed swab X3 in the main-body case 31 can be reliably fed to the discharge port 33.

When the motor 32M is caused to operate, the link member 32a rotates, and the ascending/descending unit 32b engaged with the link member 32a moves upward and downward. When the ascending/descending unit 32b moves upward and downward, the packed swabs X3 on the intermediate board 36 are pushed up by the ascending/descending unit 32b, and the packed swabs X3 having reached the discharge port 33 are discharged one by one. The discharge mechanism 32 illustrated in FIG. 6 is an example, and the discharge mechanism 32 can have a configuration other than that.

The reading means 4 is a device for reading the identification code X4 indicated on the storing tube X2. As the reading means 4, various barcode readers can be used. In this embodiment, a stationary barcode reader capable of reading a one-dimensional code and a two-dimensional code is used. As the reading means 4, means other than that can be used.

In this embodiment, the reading means 4 reads the identification code X4 when the identification code X4 indicated on the storing tube X2 reaches a readable range of the reading means 4. The read information is sent to the PC 12 and is stored in a storage unit.

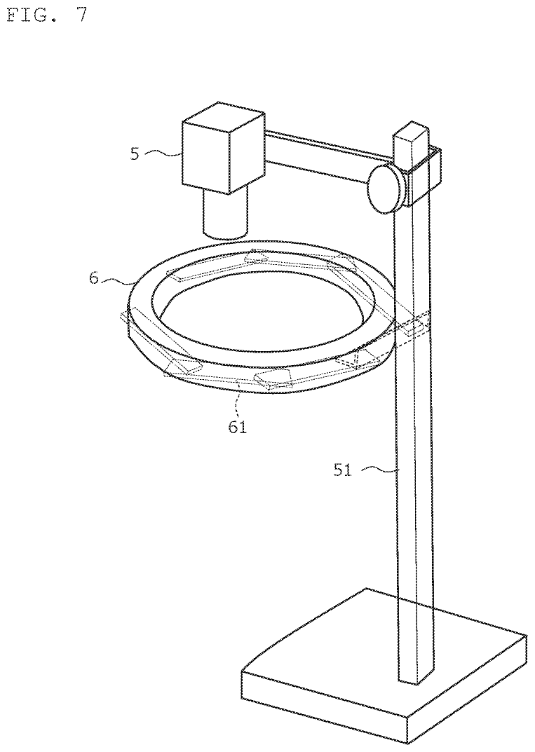

The photographing means 5 is a device for photographing the identification code X4 indicated on the storing tube X2 and the swab X. As the photographing means 5, a camera including a variable-focus lens or the like can be used. The photographing means 5 of this embodiment is attached to an attachment jig 51 so as to face downward as illustrated in FIG. 7.

This embodiment exemplifies a case in which a single camera is used, but the photographing means 5 can be formed of a plurality of cameras. For example, the photographing means 5 may be formed of three cameras, so that an object to be photographed (the swab X, for example) can be photographed from three directions, that is, an X-axis direction, a Y-axis direction, and a Z-axis direction by the three cameras. In this case, a direction in which the swab X is curved is calculated from the photographed images 15 photographed from the three directions, and a correction value can be calculated based on a result of the calculation.

The lighting unit 6 is a device for illuminating the identification code X4 and the swab X that are objects to be photographed by the photographing means 5. In this embodiment, a ring-shaped lighting unit in which an LED (a white LED in this embodiment) is mounted in a ring-shaped case is used as the lighting unit 6. The lighting unit 6 is supported by a lighting-unit support 61 such that an emission side thereof faces downward, and is attached to the attachment jig 51 to which the photographing means 5 is attached. As the lighting unit 6, units other than that can be used.

In this embodiment, when the first arm 91 moves the packed swab X3 to the photographing position, the packed swab X3 is illuminated by the lighting unit 6 and is photographed by the photographing means 5. The photographed image is sent to the PC 12 and is stored in the storage unit.

Further, when the second arm 92 moves the swab X having been cut to the photographing position, the swab X is illuminated by the lighting unit 6 and is photographed by the photographing means 5. The photographed image is sent to the PC 12 and is stored in the storage unit. Note that, in this embodiment, the swab X having been cut is photographed while being placed such that a tip end thereof (a side closer to the collecting portion X7) faces the front of the camera.

The uncapping means 7 is a device for taking off the cap X5 of the packed swab X3 from the storing tube X2. The uncapping means 7 illustrated in FIG. 8 as an example includes a guide 71 that guides the packed swab X3, the two upper rollers 72a and 72b that are placed at an interval so as to face each other, two lower rollers 73a and 73b that are placed at the same interval as the upper rollers 72a and 72b so as to face each other below the upper rollers 72a and 72b, and the fixing vise 74 that fixes the swab at a predetermined position. In this embodiment, the upper rollers 72a and 72b correspond to the pulling-up unit 72 that pulls up the cap X5.

The guide 71 of this embodiment is a cylindrical member having such an inner diameter that allows the packed swab X3 to pass therethrough. In the guide 71, an upper guide portion 71a having a shape of an outwardly expanded funnel is provided at an upper end, and a lower guide portion 71b having a shape of an outwardly expanded funnel is provided at a lower end. With the upper guide portion 71a, the packed swab X3 can be reliably guided between the upper rollers 72a and 72b and between the lower rollers 73a and 73b. With the lower guide portion 71b, the packed swab X3 raised from the side closer to the fixing vise 74 can be reliably fed upward.

The upper rollers 72a and 72b are caused to rotate in the forward direction and the backward direction by upper-roller motors 72Ma and 72Mb. Similarly, the lower rollers 73a and 73b are caused to rotate in the forward direction and the backward direction by lower-roller motors 73Ma and 73Mb. As the upper-roller motors 72Ma and 72Mb and the lower-roller motors 73Ma and 73Mb, a geared motor or the like can be used. In this embodiment, the two upper rollers 72a and 72b rotate synchronously with each other, and the two lower rollers 73a and 73b rotate synchronously with each other.

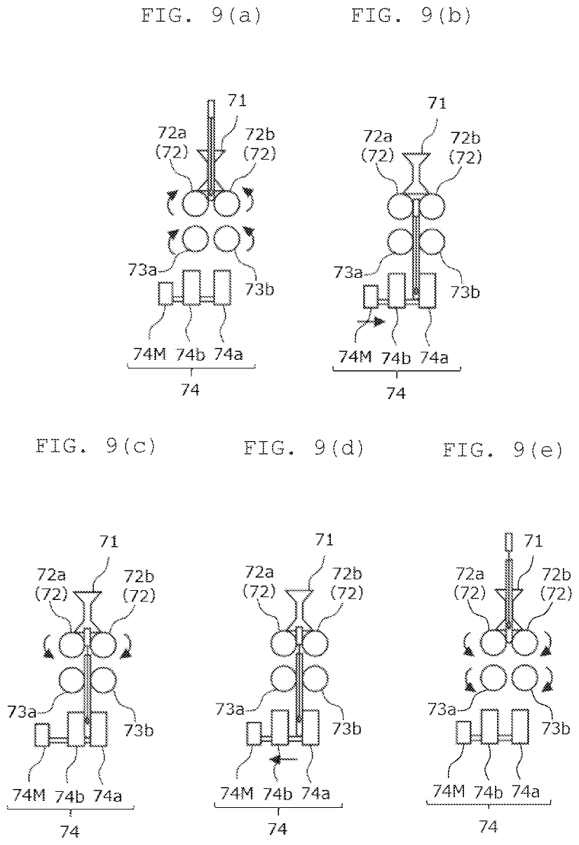

The fixing vise 74 of this embodiment includes a fixed clamping unit 74a and a movable clamping unit 74b that clamp the packed swab X3 as illustrated in FIG. 8 and FIG. 9 (a) to FIG. 9 (e). Each of respective facing surfaces of the fixed clamping unit 74a and the movable clamping unit 74b is provided with a recessed portion in which the packed swab X3 is fit. In this embodiment, the fixed clamping unit 74a is fixed onto abase 74c, and the movable clamping unit 74b is configured to be moved in a direction toward the fixed clamping unit 74a and in a direction away from the fixed clamping unit 74a, by a motor 74M and an electric actuator 74d.

The electric actuator 74d of this embodiment includes a ball screw 74f connected to the motor 74M via a coupling 74e, a support unit 74g that supports portions of the ball screw 74f in positions closer to both ends in a longitudinal direction, a table 74i fixed to a nut 74h of the ball screw 74f, and a linear guide 74j that guides the table 74i.

The movable clamping unit 74b is fixed to the table 74i such that the facing surface with a recessed portion faces the fixed clamping unit 74a. In this embodiment, when the ball screw 74f is caused to rotate in the forward direction by the motor 74M, the movable clamping unit 74b comes closer to the fixed clamping unit 74a. When the ball screw 74f is caused to rotate in the backward direction, the movable clamping unit 74b moves away from the fixed clamping unit 74a.

As illustrated in FIG. 9(a) to FIG. 9(e), in this embodiment, when the packed swab X3 is put into the guide 71, the upper rollers 72a and 72b and the lower rollers 73a and 73b rotate. Due to the rotational force, the packed swab X3 is fed to a position between the fixed clamping unit 74a and the movable clamping unit 74b of the fixing vise 74.

When the packed swab X3 is fed to the position between the fixed clamping unit 74a and the movable clamping unit 74b, the movable clamping unit 74b moves toward the fixed clamping unit 74a, and the storing tube X2 of the packed swab X3 is clamped by the fixed clamping unit 74a and the movable clamping unit 74b. When the storing tube X2 is clamped by the fixed clamping unit 74a and the movable clamping unit 74b, the upper rollers 72a and 72b in contact with the cap X5 of the packed swab X3 rotate in a direction opposite to the direction described above. Due to the rotational force, the capped swab X1 is taken out from the storing tube X2.

When the capped swab X1 is taken out from the storing tube X2, the movable clamping unit 74b moves in an opposite direction (a direction away from the fixed clamping unit 74a), and the clamping by the fixed clamping unit 74a and the movable clamping unit 74b is released. In this state, when the upper rollers 72a and 72b and the lower rollers 73a and 73b rotate in a direction opposite to the direction during feeding of the swab, the packed swab X3 is discharged to a position above the guide 71 due to the rotational force. Whether the cap X5 is taken off from the storing tube X2 is determined based on a change in a current value.

The removing means 8 is a device for removing the cap X5 of the capped swab X1 taken out from the storing tube X2. This embodiment exemplifies a case in which the removing means 8 is the cutting means 8 that cuts the shaft portion X6 of the capped swab X1. The cutting means 8 of this embodiment includes a cutter 81 that cuts the shaft portion X6, and a drive unit 82 that drives the cutter 81. In this embodiment, a cutter that is caused to operate by an impact driver, a geared motor, or the like is used. The removing means 8 may be means other than that.

In this embodiment, when the second arm 92 moves the capped swab X1 to the cutting position set in advance, a signal is sent from the second arm 92 to the microcomputer 13. In accordance with a signal from the microcomputer 13 having received the signal, the cutting means 8 is controlled such that the shaft portion X6 of the capped swab X1 is cut. A cut portion is disposed of in the disposal box (not shown).

The robot arm 9 is a robot that handles the swab X. In this embodiment, a double-arm articulated robot including the first arm 91 and the second arm 92 is used. The first arm 91 includes the first grasping portion 93, and the second arm 92 includes the second grasping portion 94. The swab X (including the elements forming the swab X, such as the storing tube X2, the cap X5, and the shaft portion X6) is grasped by the first grasping portion 93 and the second grasping portion 94. The robot arm 9 has control means 95 (FIG. 4) mounted (incorporated) therein, and the operations of the robot arm 9 are controlled by the control means 95.

In this embodiment, the first arm 91 is configured to perform at least operations of grasping the packed swab X3 discharged from the stocker 3, moving the packed swab X3 to the reading position, moving the packed swab X3 to the photographing position, putting the packed swab X3 into the uncapping means 7, grasping the cap X5 of the capped swab X1 discharged from the uncapping means 7, moving the storing tube X2 remaining in the uncapping means 7 to a position above the disposal box, and disposing of the storing tube X2 in the disposal box.

Further, in this embodiment, the second arm 92 is configured to perform at least operations of grasping the shaft portion X6 of the capped swab X1 discharged from the uncapping means 7, lowering the storing tube X2 discharged from the uncapping means 7, moving the capped swab X1 to the cutting position, moving the swab X having been cut to the photographing position, moving the swab X having been photographed to a position above the plate 14, and storing the swab X in the storing portion 14a.

The monitor 10 displays an operating condition of a system, the photographed image 15 photographed by the photographing means 5, a read signal read by the reading means 4, and the like. As the monitor 10, an existing liquid crystal display or the like can be used.

The informing means 11 is means for informing a person (operator or the like) near the system that a trouble occurs in the system when any trouble occurs. In this embodiment, a speaker is used as the informing means 11, and occurrence of a trouble can be informed of by a sound. As the informing means 11, means other than a speaker can be used.

The PC 12 is configured to give an instruction to the control means 95 of the robot arm 9, process data sent from the reading means 4, the photographing means 5, and the like, and control various means such as the reading means 4, the photographing means 5, the lighting unit 6, the monitor 10, a power supply P2, the informing means 11, and the like. As the PC 12, a device including a control unit, a calculation unit, a storage unit, a sending/receiving unit, and the like can be used. In the PC 12, software for controlling the above-mentioned devices is installed. The microcomputer 13 is configured to control the stocker 3, the uncapping means 7, the removing means 8, and the like.

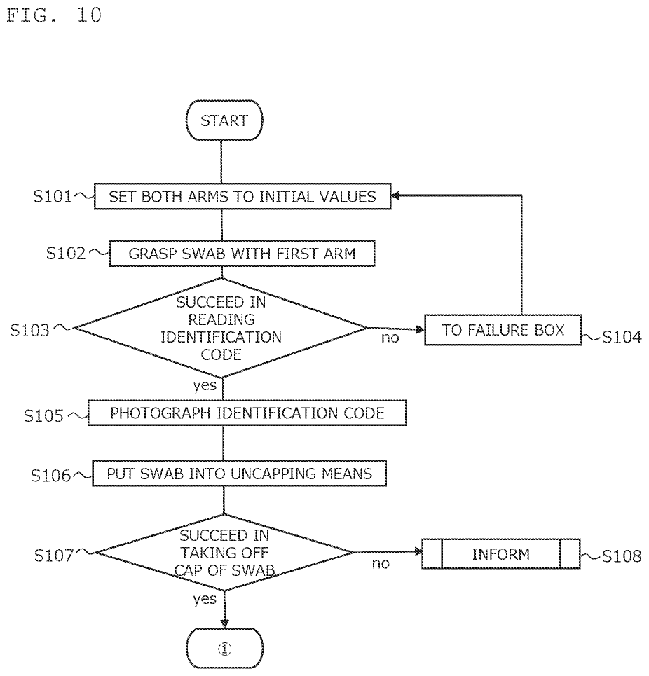

Next, an operation flow of the storing apparatus of this embodiment is described in detail with reference to FIG. 10 to FIG. 12.

(1) As illustrated in FIG. 10, in the storing apparatus of this embodiment, first, the first arm 91 and the second arm 92 are set to initial values (Step S101).

(2) The first arm 91 moves to a predetermined position near the stocker 3, grasps the packed swab X3 discharged to the receiving portion 34 of the stocker 3 by using the first grasping portion 93 of the first arm 91, and takes out the packed swab X3 (Step S102).

(3) The packed swab X3 grasped by the first grasping portion 93 of the first arm 91 is moved to the reading position of the reading means 4, and the reading means 4 reads the identification code X4 (Step S103).

(4) When the reading means 4 fails to read, the packed swab X3 is stored in a failure box (not shown) (Step S104). After that, the first arm 91 and the second arm 92 are set to the initial values (Step S101).

(5) Meanwhile, when the reading means 4 succeeds in reading, the first arm 91 moves the packed swab X3 to the photographing position of the photographing means 5, and the photographing means 5 photographs the identification code X4 indicated on the storing tube X2 (Step S105).

(6) After the photographing means 5 finishes photographing, the first arm 91 moves the packed swab X3 to a position above the guide 71 of the uncapping means 7, and the packed swab X3 is put into the guide 71 (Step S106).

(7) The cap X5 of the packed swab X3 put into the uncapping means 7 is taken off (Step S107).

(8) When the uncapping means 7 fails to take off the cap X5 from the storing tube X2, the informing means 11 informs accordingly (Step S108).

(9) Meanwhile, when the uncapping means 7 succeeds in taking off the cap X5, the first grasping portion 93 of the first arm 91 grasps the cap X5 of the capped swab X1, which is then raised approximately 10 cm (Step S109).

(10) After the capped swab X1 is raised, determination is made on whether the second grasping portion 94 of the second arm 92 can grasp the shaft portion X6 of the capped swab X1 (Step S110).

(11) When it is determined that the second arm 92 cannot grasp the shaft portion X6, determination is made on whether the number of times of lowering the storing tube X2 reaches the number (“n” times) set in advance (Step S111).

(12) When it is determined that the number of times of lowering the storing tube X2 does not reach the “n” times, the second arm 92 lowers the storing tube X2 (Step S112).

(13) When it is determined that the number of times of lowering the storing tube X2 reaches the “n” times, the informing means 11 informs accordingly (Step S113).

(14) Meanwhile, when it is determined that the second arm 92 can grasp the shaft portion X6, the second grasping portion 94 of the second arm 92 grasps the shaft portion X6 of the capped swab X1 (Step S114).

(15) After the second grasping portion 94 of the second arm 92 grasps the shaft portion X6 of the capped swab X1, the capped swab X1 is moved to the cutting position of the removing means (cutting means) 8, and the cutting means 8 cuts the shaft portion X6 of the capped swab X1 (Step S115).

(16) After the cutting means 8 finishes cutting the shaft portion X6, the swab X that has been cut and is grasped by the second grasping portion 94 of the second arm 92 is moved to the photographing position of the photographing means 5, and the photographing means 5 photographs the swab X (Step S116).

(17) After the photographing means 5 finishes photographing, the outline shape 16 of the swab X is specified from the photographed image 15 (Step S117).

(18) After the outline shape 16 is specified, determination is made on whether the outline shape 16 fits within the reference frame 18 (Step S118).

(19) When it is determined that the outline shape 16 does not fit within the reference frame 18, determination is made on whether correction is possible (Step S119).

(20) When it is determined that correction is not possible, the second arm 92 moves the swab to a predetermined position (a position set in advance as a position where an operator can easily take the swab) (Step S120), and the informing means 11 informs accordingly (Step S121).

(21) Meanwhile, when it is determined that correction is possible, a correction value (values of movement in the X-axis direction and the Y-axis direction) is calculated in the PC 12 (Step S122). The X-axis direction and the Y-axis direction referred to here mean not axes on a plane horizontal to the setting stand 1, but the X-axis direction and the Y-axis direction on an imaginary plane parallel to the upper surface of the plate 14 set on the plate seat 2.

(22) Meanwhile, when it is determined that the outline shape 16 fits within the reference frame 18, or it is determined that correction is possible, determination is made on whether the predetermined plate 14 designated by the identification code X4 includes the vacant storing portion 14a (Step S123).

(23) When it is determined that the predetermined plate 14 does not include the vacant storing portion 14a, the informing means 11 informs accordingly (Step S124).

(24) Meanwhile, when it is determined that the predetermined plate 14 includes the vacant storing portion 14a, the second arm 92 moves the swab X having been cut to a position above the vacant storing portion 14a (Step S125).

(25) After the swab X having been cut is moved to the position above the vacant storing portion 14a, determination is made on whether correction is required (Step S126).

(26) When it is determined that correction is not required, that is, it is determined that the outline shape 16 fits within the reference frame 18 without correction, the grasp by the second arm 92 is released above the vacant storing portion 14a, so that the swab X having been cut is stored in the vacant storing portion 14a (Step S127).

(27) Meanwhile, when it is determined that correction is required, the second arm 92 moves in the X-axis direction and/or the Y-axis direction in accordance with the correction value calculated in the above-mentioned item (21), and the position of the swab X is corrected (Step S128).

(28) After the correction is completed, the grasp by the second arm 92 is released in the corrected position, and the swab X having been cut is stored in the vacant storing portion 14a (Step S127).

(29) After the swab X having been cut is stored in the vacant storing portion 14a, the storing tube X2 remaining in the uncapping means 7 is taken out by the first arm 91 and is disposed of in the disposal box (not shown) (Step S129).

Note that, although this embodiment exemplifies a storing apparatus including all of the setting stand 1, the plate seat 2, the stocker 3, the reading means 4, the photographing means 5, the lighting unit 6, the uncapping means 7, the removing means 8, the robot arm 9, the monitor 10, the informing means 11, the PC 12, and the microcomputer 13, all of the above-mentioned components are not essential, and components which are not required can be omitted as appropriate.

For example, the photographing means 5 can be omitted when recording is not required, and the removing means 8 can be omitted when the storing portion 14a can receive a capped swab as it is. Further, those components are regarded as individual inventions.

The present invention is not limited to the structures and shapes in the above-mentioned embodiment, and various modifications and alterations are possible without departing from the gist thereof.

### INDUSTRIAL APPLICABILITY

The storing method and the storing apparatus according to the present invention can encourage automation of an operation of storing the swab X in the storing portion 14a of the plate 14, reduction of a contamination risk, and reduction of a period of time that a researcher having expertise is required to take to do simple work, and needless to say, it should be understood that the industrial applicability thereof is acknowledged.

### REFERENCE SIGNS LIST

1 setting stand
2 plate seat
3 stocker
4 reading means
5 photographing means
6 lighting unit
7 uncapping means
8 removing means (cutting means)
9 robot arm
10 monitor
11 informing means
12 computer (PC)
13 microcomputer
14 plate (predetermined plate)
14a storing portion (predetermined storing portion, vacant storing portion)
14b fitting portion
14c insertion port
14d notched surface
15 photographed image
16 outline shape
17 central point
18 reference frame
21 mounting surface
22 fitting groove
23 flange
31 main-body case
31a front board
31b back board
32 discharge mechanism
32M motor (geared motor)
32a link member
32b ascending/descending unit
33 discharge port
34 receiving portion
35 spill stopper
36 intermediate board
51 attachment jig
61 lighting-unit support
71 guide
71a upper guide portion
71b lower guide portion
72 pulling-up unit
72a upper roller
72b upper roller
72Ma upper roller motor
72Mb upper roller motor
73Ma lower roller motor
73Mb lower roller motor
73a lower roller
73b lower roller
74 fixing vise
74a fixed clamping unit
74b movable clamping unit
74c base
74d electric actuator
74e coupling
74f ball screw
74g support unit
74h nut
74i table
74j linear guide
74M motor
81 cutter
82 drive unit
91 first robot arm (first arm)
92 second robot arm (second arm)
93 grasping portion of first arm (first grasping portion)
94 grasping portion of second arm (second grasping portion)
X medical swab (swab)
X1 capped swab
X2 storing tube
X3 packed swab
X4 identification code (barcode)
X5 cap
X6 shaft portion
X7 collecting portion

1. A medical swab storing method of storing a medical swab in a storing portion of a medical plate, comprising:
grasping the medical swab having collected a specimen, by using a grasping portion provided in a robot arm;
moving the grasped medical swab to a position above a predetermined storing portion of a predetermined plate; and
storing the medical swab in the predetermined storing portion of the predetermined plate.

2. The medical swab storing method according to claim 1, wherein the medical swab moved to the position above the predetermined storing portion is stored in the predetermined storing portion after being stopped for a predetermined period of time.

3. The medical swab storing method according to claim 1, wherein a cap of the medical swab is removed before the medical swab is moved to the position above the predetermined storing portion of the predetermined plate.

4. The medical swab storing method according to claim 1, further comprising:
photographing the medical swab grasped by the grasping portion, by using photographing means;
specifying a shape of the medical swab from a photographed image obtained by the photographing; and
determining whether the specified shape complies with a standard set in advance.

5. The medical swab storing method according to claim 4, wherein a position of the medical swab is corrected when the specified shape does not comply with the standard.

6. The medical swab storing method according to claim 5, wherein the medical swab is corrected by moving the robot arm in an X-axis direction and/or a Y-axis direction on an imaginary plane parallel to an upper surface of the medical plate.

7. The medical swab storing method according to claim 1, further comprising:
reading an identification code indicated on a storing tube in which the medical swab is stored, by using reading means; and
storing the medical swab in a storing portion of a medical plate designated by the identification code.

8. The medical swab storing method according to claim 7, wherein, before the medical swab is stored in the storing portion of the medical plate designated by the identification code, determination is made on whether the medical plate includes a vacant storing portion capable of receiving the medical swab.

9. The medical swab storing method according to claim 1, further comprising:
putting the medical swab grasped by the robot arm into uncapping means;
fixing a storing tube of the medical swab by using fixing means of the uncapping means; and
taking off the cap from the storing tube by causing a pulling-up unit in contact with a cap of the medical swab to operate.

10. A medical swab storing apparatus that stores a medical swab in a storing portion of a medical plate, comprising:
a robot arm including a grasping portion; and
control means configured to control the robot arm,
wherein the robot arm operates so as to move the grasped medical swab to a position above a predetermined storing portion of a predetermined plate and release grasp by the grasping portion above the predetermined storing portion so that the medical swab is stored in the predetermined storing portion, under control of the control means.

11. The medical swab storing apparatus according to claim 10, wherein the robot arm stops for a predetermined period of time above the predetermined storing portion under control of the control means.

12. The medical swab storing apparatus according to claim 10, further comprising
removing means configured to remove a cap of the medical swab,
wherein the robot arm operates so as to move the grasped medical swab to a removal position of the removing means under control of the control means, and
wherein the cap of the medical swab moved to the removal position is removed by the removing means.

13. The medical swab storing apparatus according to claim 10, further comprising
photographing means configured to photograph the medical swab grasped by the grasping portion,
wherein a shape of the medical swab is specified from a photographed image obtained by the photographing, and determination is made on whether the specified shape complies with a standard set in advance.

14. The medical swab storing apparatus according to claim 13, wherein a position of the medical swab is corrected when the specified shape does not comply with the standard set in advance.

15. The medical swab storing apparatus according to claim 14, wherein the medical swab is corrected by moving the robot arm in an X-axis direction and/or a Y-axis direction on an imaginary plane parallel to an upper surface of the medical plate.

16. The medical swab storing apparatus according to claim 10, further comprising
reading means configured to read an identification code indicated on a storing tube in which the medical swab is stored,
wherein the robot arm operates so as to store the medical swab in a storing portion of a medical plate designated by the identification code under control of the control means.

17. The medical swab storing apparatus according to claim 16, wherein determination is made on whether the medical plate designated by the identification code includes a vacant storing portion capable of receiving the medical swab.

18. The medical swab storing apparatus according to claim 10, further comprising
uncapping means configured to take off a cap of the medical swab from a storing tube,
wherein the uncapping means includes fixing means configured to fix the storing tube and a pulling-up unit configured to come into contact with the cap and pull up the cap.
